(19) United States
(12) Patent Application Publication
(10) Pub. No.: US 2011/0205025 A1
(43) Pub. Date: Aug. 25, 2011

(54) CONVERTING BETWEEN DIFFERENT RADIO FREQUENCIES

(75) Inventors: Bruce B. Roesner, Durham, NC (US); Thomas J. Frederick, Chapel Hill, NC (US)

(73) Assignee: Sirit Technologies Inc., Toronto (CA)

(21) Appl. No.: 12/710,999

(22) Filed: Feb. 23, 2010

(51) Int. Cl. G06K 7/01

(52) U.S. Cl. 340/10.1

(57) ABSTRACT

The present disclosure is directed to a system and method for converting between different radio frequencies. In some implementations, a method includes receiving a request from a Radio Frequency Identification Device (RFID) reader configured to communicate with a first type of RFID tag. Independent of digital signal processing, the received request is automatically converted to a request compatible with a second type of RFID tag different from the first type of RFID tag. The converted request is transmitted to an RFID tag of the second type of RFID tag.

### TECHNICAL FIELD

This application relates to converting between different radio frequencies.

### BACKGROUND

In some cases, an RFID reader operates in a dense reader environment, i.e., an area with many readers sharing fewer channels than the number of readers. Each RFID reader works to scan its interrogation zone for transponders, reading them when they are found. Because the transponder uses radar cross section (RCS) modulation to backscatter information to the readers, the RFID communications link can be very asymmetric. The readers typically transmit around 1 watt, while only about 0.1 milliwatt or less gets reflected back from the transponder. After propagation losses from the transponder to the reader the receive signal power at the reader can be 1 nanowatt for fully passive transponders, and as low as 1 picowatt for battery assisted transponders. At the same time other nearby readers also transmit 1 watt, sometimes on the same channel or nearby channels. Although the transponder backscatter signal is, in some cases, separated from the readers' transmission on a sub-carrier, the problem of filtering out unwanted adjacent reader transmissions is very difficult.

### SUMMARY

The present disclosure is directed to a system and method for converting between different radio frequencies. In some implementations, a method includes receiving a request from a Radio Frequency Identification Device (RFID) reader configured to communicate with a first type of RFID tag. Independent of digital signal processing, the received request is automatically converted to a request compatible with a second type of RFID tag different from the first type of RFID tag. The converted request is transmitted to an RFID tag of the second type of RFID tag.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a block diagram illustrating an example system for converting between different types of RFID signals;

FIG. 2 is an example diagram of a portion of the slave transceiver of FIG. 1 in accordance with some implementations;

FIG. 3 is a flow chart illustrating an example method for converting between RFID signals independent of digital signal processing;

FIGS. 4A-C are block diagram illustrating different communication designs; and

FIG. 5 illustrates an example system of FIG. 1.

Like reference symbols in the various drawings indicate like elements.

### DETAILED DESCRIPTION

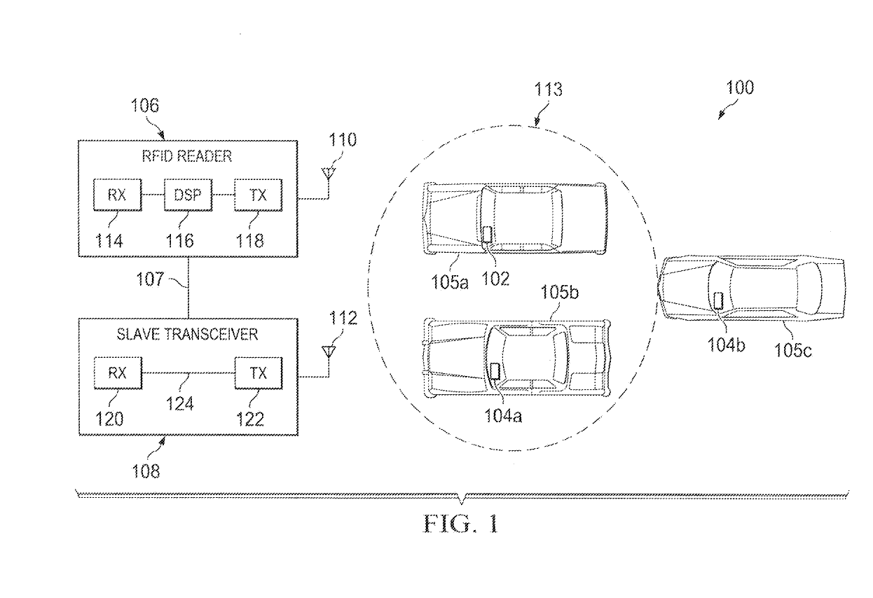

FIG. 1 is an example system 100 for converting Radio Frequency (RF) signals between different standards. RF standards typically identify signals aspects (e.g., frequency), formats (e.g., protocols), and/or other attributes of signals. RF Identifier (RFID) standards include ISO 18000-6C (GEN 2), DSRC, ISO 18000-6B, ISO 10374, ATSMv6, and/or others. For example, the system 100 may receive RF signals transmitted at a first frequency and convert the RF signals to RF signals transmitted at a different frequency. In some implementations, the system 100 may convert between two different RF signals independent of digital signal processing. In other words, the system 100 may receive an RF signal transmitted in accordance with a first standard and convert the signal to a form compatible with a second standard independent of digitally signal processing. For example, the system 100 may convert between different RF signals without using an Analog-to-Digital Converter (ADC), a Digital-to-Analog Converter (DAC), a Digital Signal Processor (DSP), and/or other digital elements. In these examples, the system 100 may demodulate a signal in a first frequency to baseband and directly modulate the baseband to a signal in a second frequency independent of digital signal processing. In addition, the system 100 may passively convert between two different types of RF signals. In other words, the system 100 may convert a signal from a first type of signal to a second type of signal independent of a power supply (e.g., wired power connection, battery). In general, the system 100 may perform one or more of the following: receive RF signals through a wireless and/or wired connection (e.g., commands, replies); select one of a plurality of different types of RF signals; convert a received RF signal from a first type of RF signal to a different type of RF signal independent of digital signal processing; transmit the converted RF signals to the associated RF reader or RFID tags; and/or others. In operating the system 100 in accordance with some of these implementations, the system 100 may minimize, eliminate or otherwise reduce costs for communicating with new and/or different RFID tags.

At a high level, the system 100 can, in some implementations, include one or more RFID tags 102 and 104, a reader 106 and a slave transceiver 108. The RFID tags 102 may be a different type of tag than RFID tags 104. For example, the RFID tags 102 may communicate at a first frequency and the RFID tags 104 may communicate at a second frequency different from the first frequency. The RFID tags 102 and/or 104 may directly or indirectly communicate with the RFID reader 106 through an antenna 110. In certain implementations, the RFID tags 104 can communicate with the RFID reader 106 using the slave transceiver 108 and the antenna 112. For example, the slave transceiver 108 may convert wireless communication between signals compatible with the reader 106 and signals compatible with the tags 104. During the conversions, the transceiver 108 may modify or otherwise update one or more attributes of a signals such as frequency, phase, amplitude, and/or other attributes. In these instances, the conversions may be transparent to the tags 104 and/or the reader 106. The transceiver 108 communicates with the reader 106 through the connection 107. The connection 107 may be a wired and/or wireless connection. For example, the connection 107 may be a wired connection (e.g., coaxial cable) to the antenna 110, wireless connection with the antenna 110, wired connection to a port (e.g., serial), and/or other type of connection.

The RFID tags 102 and/or 104 can include any software, hardware, and/or firmware configured to directly or indirectly, i.e., via transceiver 108, respond to communication from the RFID reader 106. These tags 102 and/or 104 may operate without the use of an internal power supply. Rather, the tags 102 and/or 104 may transmit a reply to a received signal using power stored from the previously received RF signals, independent of an internal power source. This mode of operation is typically referred to as backscattering. In some implementations, the tags 102 and/or 104 can alternate between absorbing power from signals transmitted by the RFID reader 106 and transmitting responses to the signals using at least a portion of the absorbed power. In passive tag operation, the tags 102 and/or 104 typically have a maximum allowable time to maintain at least a minimum DC voltage level. In some implementations, this time duration is determined by the amount of power available from an antenna of a tag 102 and/or 104 minus the power consumed by the tag 102 and/or 104 and the size of the on-chip capacitance. The effective capacitance can, in some implementations, be configured to store sufficient power to support the internal DC voltage when there is no received RF power available via the antenna. The tag 102 and/or 104 may consume the stored power when information is either transmitted to the tag 102 and/or 104 or the tag 102 and/or 104 responds to the RFID reader 106 (e.g., modulated signal on the antenna input). In transmitting responses back to the RFID reader 106, the tags 102 and/or 104 may include one or more of the following: an identification string, locally stored data, tag state, internal temperature, and/or others. For example, the tag 102 and/or 104 may transmit information including or otherwise identifying vehicle information such as type, weight, vehicle height, tag height, account number, owner information (e.g., name, license number), and/or other information. In some implementations, the signals can be based, at least in part, on sinusoids having frequencies in the range of 902-928 MHz, 2400-2483.5 MHz, or about 5.9 Ghz. In some implementations, an RFID tag 102 and/or 104 may be of a type manufactured to support the ISO 18000-6C standard. An RFID tag manufactured to ISO 18000-6C standard may support dual states: an A state, in which the RFID tag is responsive to RF interrogation, and a B state, in which the RFID tag is temporarily unresponsive to RF interrogation. Under the ISO 18000-6C standard, an RFID tag may typically remain in an unresponsive B state for between 0.8 seconds and 2.0 seconds even without any further power being supplied to the RFID tag 102 and/or 104.

The RFID reader 106 can include any software, hardware, and/or firmware configured to transmit and receive RF signals. In general, the RFID reader 106 may transmit a request for information within a certain geographic area, or interrogation zone 113, associated with the reader 106. The reader 106 may transmit the query in response to a request, automatically, in response to a threshold being satisfied (e.g., expiration of time), as well as other events. The interrogation zone 113 may be based on one or more parameters such as transmission power, associated protocol, nearby impediments (e.g., objects, walls, buildings), as well as others. In general, the RFID reader 106 may include a controller, a transceiver coupled to the controller, and at least one RF antenna 110 coupled to the transceiver. In the illustrated example, the RF antenna 110 transmits commands generated by the controller through the transceiver and receives responses from RFID tags 102, RFID tags 104 and/or antennas 110 in the associated interrogation zone 113. In certain cases such as tag-talks-first (TTF) systems, the reader 106 may not transmit commands but only RF energy. In some implementations, the controller can determine statistical data based, at least in part, on tag responses. The reader 106 often includes a power supply or may obtain power from a coupled source for powering included elements and transmitting signals. In some implementations, the reader 106 operates in one or more of frequency bands allotted for RF communication. For example, the Federal Communication Commission (FCC) has assigned 902-928 MHz and 2400-2483.5 MHz as frequency bands for certain RFID applications. In some implementations, the reader 106 may dynamically switch between different frequency bands. For example, the reader 106 may switch between European bands 860 to 870 MHz and Japanese frequency bands 952 MHz to 956 MHz. Some implementations of system 100 may further include an RFID reader 106 to control timing, coordination, synchronization, and/or signal strength of transmissions by inhibitor antenna and RFID antenna.

In some implementations, the reader 106 can include a receiver module 114, a Digital Signal Processor (DSP) 116 and a transmission module 118. The receiver module 114 can include any software, hardware, and/or firmware configured to receive RF signals from the tags 102 and/or the transceiver 108 and can down convert the received signal to digital signals for the DSP 116. For example, the receiver module 114 may convert an RF signal to a baseband signal and, in turn, convert the baseband signal to a digital signal using, for example, an ADC. In some implementations, the baseband signal is a low frequency signal (e.g., DC to 400 KHz). In addition, the receiver module 114 may perform other functions such as amplification, filtering, conversion between analog and digital signals, and/or others. The receiver module 114 may produce the baseband signals using a mixer and low pass filters (not illustrated). In some implementations, the receiver module 114 includes a low noise amplifier (LNA), a mixer, a low pass filter (LPF), and a dual ADC (not illustrated).

The receiver module 114 passes or otherwise directs the baseband signals to the digital signal processor (DSP) 116. The DSP 116 can include any software, hardware, and/or firmware operable to process the digital signal. For example, the DSP 116 may generate control signals for adjusting a cancellation signal used to compensate for leakage signal. In some implementations, the DSP 116 compensates the baseband signals for DC offset and/or phase offset. As mentioned above, the reader 100 may include elements that subtract DC offsets and/or de-rotate phase offsets in the baseband signals. Otherwise, these offsets can reduce the efficacy of the cancellation signal in reducing the leakage signal. In other words, the DSP 116 may eliminate, minimize, or otherwise reduce the DC offset and/or the phase offset to reduce error in the cancellation signal. In the case of DC offset, the DSP 116 can, in some implementations, subtract estimates of the DC offsets in the baseband signals such as the in-phase signal and the quadrature signal. For example, the DSP 116 may determine samples (e.g., hundreds of samples) of the DC offset for the baseband signals and generate an average for each baseband signal based, at least in part, on the samples. In this example, the DSP 116 may subtract the DC offset from the corresponding baseband signal during steady state. In regards to the phase offset, the DSP 116 may introduce a phase shift in the baseband signals to minimize, eliminate, or otherwise reduce the phase shift generated by the elements in the reader 100. In some cases, varying a control value on one baseband signal (e.g., in-phase signal) can produce a change on the other baseband signal (e.g., quadrature signal). This cross-coupling between the two baseband signals can, in some implementations, lead to a more complex control algorithm for compensating for the phase shift offset. In addition, the DSP 116 may analyze the received information such as detecting the signal from a background noise including unwanted DC level shifts and/or signal changes outside the baseband of interest.

The transmitter module 106 can include any software, hardware, and/or firmware operable to generate transmission signals for RFID tags 102. In the illustrated implementation, the transmitter module 106 can include a digital-to-analog converter (DAC), a LPF, a transmission mixer, a power amplifier, and/or other elements. The DAC may receive a digital signal from the DSP 116 and converts the digital signal to an analog baseband signal. For example, the digital signal can encode queries for tags 102 to identify associated information. The DAC may pass the analog signal to an LPF to attenuate frequencies higher than a cutoff frequency from the analog signals. The LPF may pass the analog signals to the transmission mixer to upconvert the baseband signals to an RF signals. In this case, the transmission mixer may receive a signal from a frequency synthesizer and mix this signal with the analog signal to generate the RF signal.

In some implementations, the transceiver 108 can provide internetworking between the reader 106 and tags 104. For example, the transceiver 108 may internetwork signals compatible with a first standard and signals compatible with a second standard. As appropriate, the transceiver 108 can include any software, hardware, and/or firmware operable to convert between a first type of wireless signal and a second type of wireless signal. In some implementations, the transceiver 108 can receive a wireless message from the reader 106 at a first frequency, automatically convert the wireless message to a second frequency, and transmit the converted message to the tag 104. In a first example, the auxiliary transceiver 108 may convert the reader signals from one carrier frequency to another carrier frequency by converting to/from baseband as an intermediate step (e.g., FIG. 2). In a second example, the auxiliary transceiver 108 may convert the reader signals from one carrier frequency to another by directly converting between the two frequencies (e.g., FIG. 5). In both examples, the reader 106 may be configured to modulate/demodulate both tag protocols for tags 102 & 104 and may not include hardware that enables processing of both frequencies. In these instances, the auxiliary transceiver 108 may extend the frequency range of the reader 106. In some implementations, the transceiver 108 may modify or otherwise update one or more attributes of a signals such as frequency, phase, amplitude, and/or other attributes independent of digitally processing the signal. In some implementations, the transceiver 108 may update a single attribute, a plurality of attributes or all attributes of the signal without departing from the scope of the disclosure.

In some implementations, the transceiver 108 may emulate or otherwise represent itself as a tag 102 to the reader 106 and/or a compatible reader to the tags 104. Thus, the reader 106 may query the transceiver 108 like any other tag 102 in the system 100. In addition, the tags 104 may transmit replies to the transceiver 108 as if transmitting replies to a compatible reader. In these instances, the transceiver 108 can include any software, hardware, and/or firmware operable to provide foreign communications to the reader 106 and/or the tags 104. For example, the transceiver 108 may provide the reader 106 communications from the tags 104. In providing foreign communications, the transceiver 108 may perform one or more of the following: identify the reader 106 requesting the communication; identify the tag 104 associated with requested communication; determine whether the communication is foreign; and/or translate or otherwise convert communications to forms compatible with the reader 106. As previously mentioned, the transceiver 108 may convert messages between different standards independent of digital signal processing. For example, the transceiver 108 may convert a received wireless signal to baseband and the baseband signal to a different type of wireless signal without digitally processing the signal. In some implementations, the transceiver 108 may convert communications independent of any digital elements such as ADCs, DACs, DSPs, and/or others. In doing so, the transceiver 108 may eliminate, minimize, or otherwise reduce the cost of upgrading the system 100 to communicate with new and/or different tags 104. In addition, the transceiver 108 may passively convert communications. For example, the transceiver 108 may use power from received wireless signals to convert the signals to different types of communications without relying on external power supplies, international batteries, and/or other elements.

In the illustrated implementation, the transceiver 108 includes a receiver module 120 directly to a transceiver module 122 through the connection 124. The receiver module 120 can include any software, hardware, and/or firmware configured to receive wireless signals from the reader 106 and/or the tags 104 and downconvert the signals to baseband. The receiver module 120 passes the baseband signal directly to the transceiver module 122 using the connection 124. In some implementations, the baseband signal is passed to the transmitted module 122 independent of digital signal processing. For example, the receiver module 120 may pass the baseband signal to the transmitted module 122 independent of ADC, DAC, and/or other digital processing elements. The transmitter element 122 upconverts the baseband signal to signals compatible with the reader 106 and/or the tags 104.

In some aspects of operation, the RFID reader 106 transmits a request for information from tags 102 and/or 104 in the interrogation zone. The receiver 120 receives the request and downconverts the request to a baseband signal. In some implementations, the receiver 120 passively downconverts the received request independent of a power supply. The receive 120 may directly pass the baseband signal to the transmitter module 122 through the connection 124. The transmitter module 122 upconverts the baseband to a signal at frequency different from the received signal and transmits the converted request to the interrogation zone. In some implementations, the transmitter module 122 may convert the request to a different protocol such as from GEN2 to DSRC. The tags 104 receive the converted request and transmit a reply compatible with the perceived reader. Again, the transceiver 108 may convert the reply to a form compatible with the reader 106 and transmits the converted reply to the reader 106.

FIG. 2 is a block diagram illustrating an modulation module 200 configured to modulate signals from UHF to baseband to signals at 5.9 GHz and demodulate signals at 5.9 GHz to baseband to UHF. In the illustrated example, the modulation module 200 passively modulates and demodulates signals. In other words, the example module 200 uses passive elements to convert between UHF signals and signals at 5.9 GHz. In particular, the module 200 includes diodes 202a and 202b, amplifier 204, resister 206 and capacitor 208. Introducing a modulated UHF signal onto the UHF node will result in the baseband signal being formed at the junction of the diode 202a. resistor 206, and capacitor 210. The proper selection of the R and C values will allow for the detection of the baseband but filter the carrier signal. The baseband signal can then be amplified with amplifier 204 to generate the proper signal level to drive the 5.9 GHz transmitter. When the 5.9 GHz receiver detects a response from the tag it will amplify the signal and generate a baseband signal that is used to drive the gate of transistor 208. Turning transistor 208 “On” and “Off” causes a signal to be generated on the UHF node in the same fashion that backscattering is performed in a typical tag. This modulated UHF signal can then be detected by the RFID reader. During the time that the 5.9 GHz receiver is active amplifier 204 must be deactivated so as not to allow the signal to be transmitted. In general, 4-quadrant signals (e.g., 802.11p, suppressed carrier signal like Gen2 PR-ASK) may execute linear demodulation/remodulation to correctly translate the signal. Chopper modulation may work on large carrier AM signals like DSK-ASK or AM tag backscatter.

FIG. 3 is a flowchart illustrating an example method 300 for converting RFID signals between different types of signals. Generally, the method 300 describe example techniques for internetworking a RFID reader with a foreign RFID tag. In particular, the method 300 describes converting a signal from a first frequency to a second frequency independent of digital signal processing. A transceiver may use any appropriate combination and arrangement of logical elements implementing some or all of the described functionality.

Method 300 begins at step 302 where a request for information is received from an RFID reader. For example, the transceiver 108 of FIG. 1 may request a request from the reader 106. At step 304, the request is demodulated from a first frequency to baseband. In the example, the receiver module 120 may demodulate the received request to baseband and pass the signal directly to the transmitter module 120. At step 308, the baseband signal is converted to a signal in a different protocol. The baseband signal is modulated to generate a request at a second frequency different from the first frequency at 310. Returning to the example, the transmitter module 122 may receive the baseband signal and modulate the signal to generate a request at a different frequency. The transmitter module 122 transmits the converted request to the tags 104. At step 312, the converted request is transmitted to the interrogation zone. As for the example, the transmitter module 122 transmits the converted request to the interrogation zone 113 including the tag 104. Next, at step 314, a reply transmitted at the second frequency is received from the RFID tag. Again in the example, the tag 104 transmits a reply at the second frequency to the transceiver 108. The included information is identified at step 316 and reply compatible with the RFID reader is generated using the information. As for the example, the receiver module 120 may demodulate the reply to baseband and the transmitter module 122 may modulate the baseband signal to a reply compatible with the RFID reader 106. At step 320, the compatible reply is transmitted at the first frequency to the RFID reader.

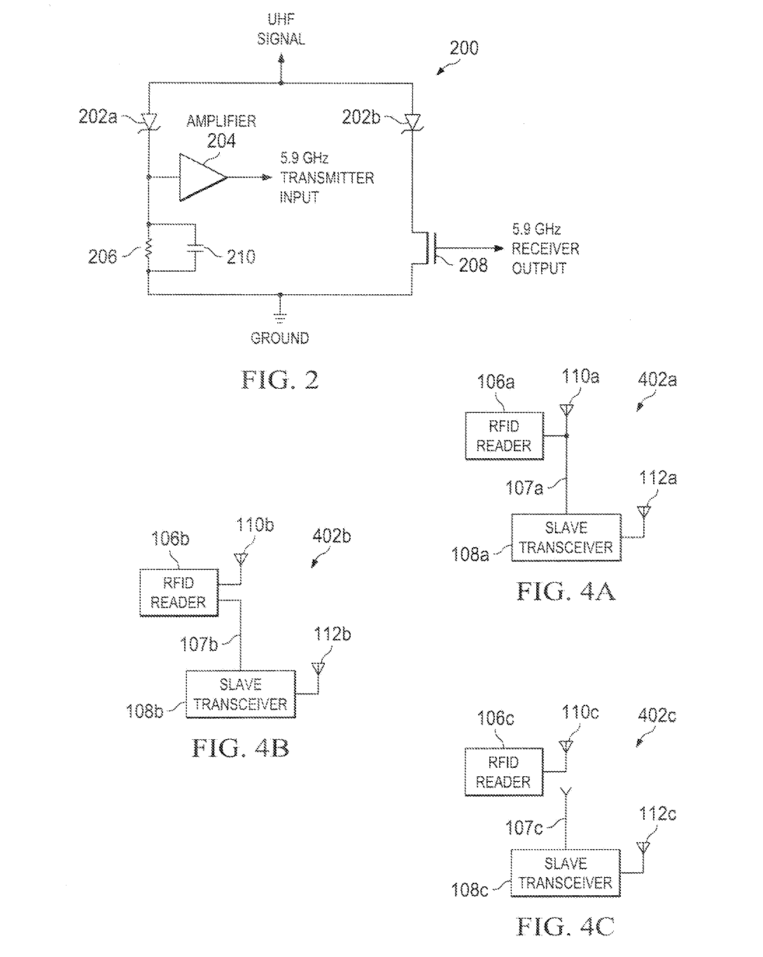

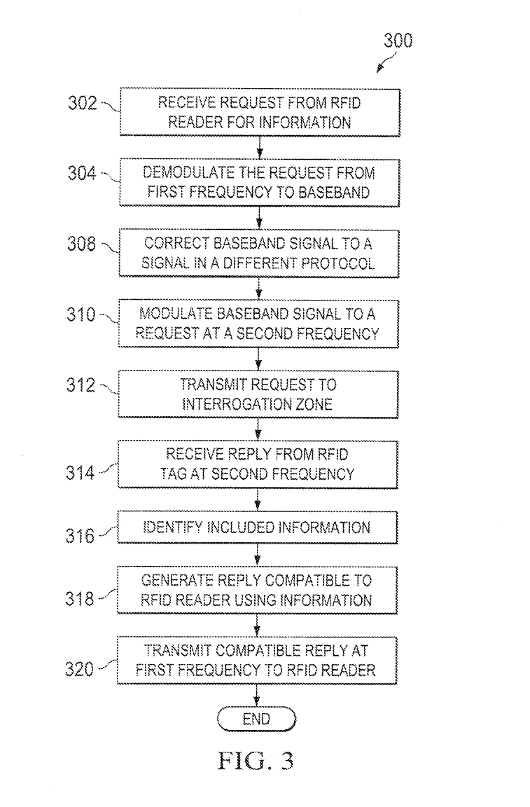

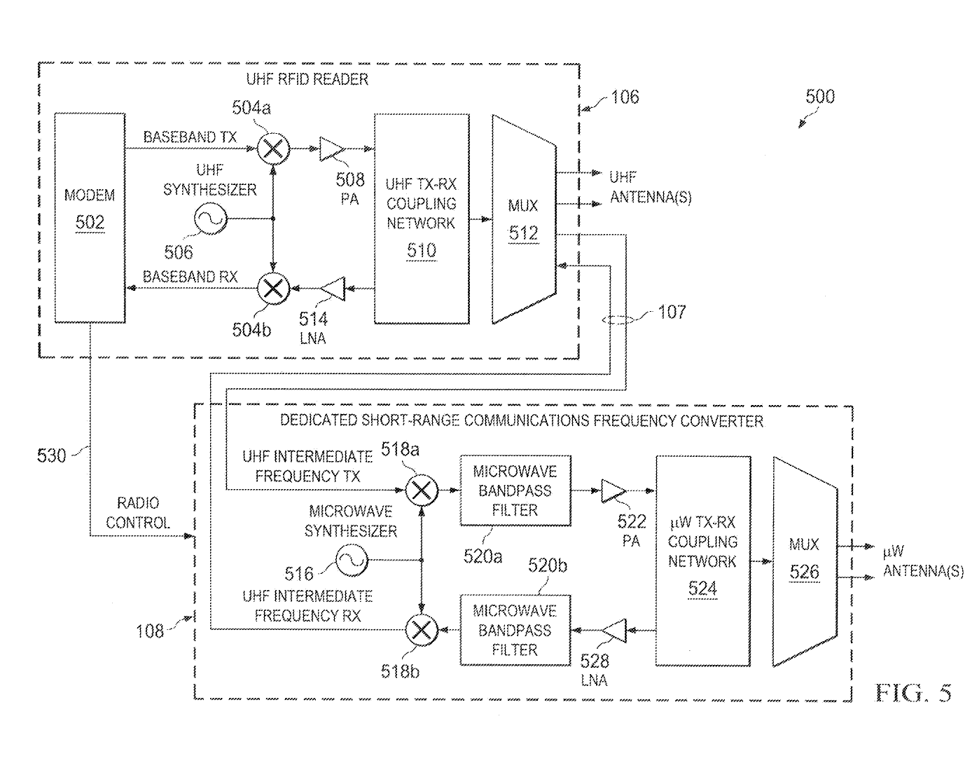

FIGS. 4A-C illustrate example connections 107a-c between the reader 106 and the transceiver 108. In particular, systems 402a-c illustrate different types of wired and wireless connections. Referring to FIG. 4A, the system 402a illustrates a wired connection 107a connected to the antenna 110a of the reader 106a and that directly passes RF signals between the reader 106 and the transceiver 108. In some implementations, two different frequencies may operate simultaneously in the system 402a such as 915 MHz and 5.9 GHz may operate simultaneously. Referring to FIG. 4B, the system 402b illustrates a wired connection 107b connected to a port of the reader 106b. For example, the reader port may be serial, parallel, and/or other types of ports. In the illustrated implementation, UHF RF signals are communicated between a second RF port on reader 106b and the transceiver 108b. In some implementations, two different frequencies can be broadcast separately when alternating between port 1 for the antenna 110b and port 2 for the connection 107b. For example, 915 MHz transmissions and 5.9 GHz transmissions may be broadcast separately when alternating between port 1 and 2 on the reader 106b. Referring to FIG. 4C, system 402c illustrates a wireless connection 107c between the reader 106c and the transceiver 108c. In the illustrated implementation, the connection 107c includes an antenna that wireless communicates with the antenna 110c of the reader 106c. For example, RF signals transmitted from reader 106c are detected by the antenna connected to the transceiver 108c. In some instances, two different frequencies may be communicated simultaneously such as both 915 MHz and 5.9 GHz may operate simultaneously.

FIG. 5 is a block diagram illustrating an example system 500 for communicating with at least two different types of tags. For example, the system 500 may communicate with a first type of tag using one frequency and communicate with a different type of tag using a second frequency. In some implementations, the system 500 may communicate messages using two different protocols that are generated in accordance with different RFID standards. In the illustrated implementation, the system 500 includes an example reader 106 and an example frequency converter 108. The UHF frequency may serve as an intermediate frequency with regard to a microwave frequency when communicating between the reader 106 and converter 108. For example, if the UHF radio is tuned to 915 MHz and the microwave radio is tuned to 5.89 GHz, then the microwave synthesizer may be tuned to 5.89 GHz+/−915 MHz, depending on whether the superheterodyne design was for upper or lower sideband injection. Microwave mixers may then translate signals between the tuned UHF frequency and the desired microwave frequency. In general, 802.11p uses half duplex communications with data packets organized into timeslots. The system 500 may include control channels and service channels so the converter 108 may hop between those channels. In addition, adequate guard time may be allowed for synthesizer tuning between slots. In some implementations, the system 100 can operate as a half duplex (as in backscatter RFID & DSRC) and may have a synthesizer for each the reader 106 and the converter 108. For other protocols involving full duplex frequency division multiplexing, the reader 106 and the converter 108 may use two synthesizers to provide frequency division multiplexing. The illustrated system 500 includes two ports for the UHF reader 106, one for TX and one for RX, which may reduce the complexity of the converter 108. In a bi-static reader, the TX/RX paths may remain completely separate all the way out to the ports.

In some implementations, the reader 106 may include any software, hardware, and/or firmware configured to communicate with RFID tags using RF signals. In general, the reader 106 may perform functions such as amplification, filtering, conversion between analog and digital signals, digital signal processing, noise reduction, and/or others. In illustrated implementation, the reader 106 includes a modem 502, mixers 504a and 504b, a local oscillator 506, a power amplifier (PA) 508, a UHF TX-RX coupling network 510, a multiplexer (MUX) 512, and a low noise amplifier (LNA) 514. In the transmit path, the modem 502 passes baseband signals to the mixer 504, and the local oscillator 506 passes a UHF signal to the mixer 504a. The mixer 504a modulates the baseband signal using the UHF signal to generate transmission signals for a first type of tag or signals for conversion by the converter 108. The PA 508 amplifies the modulated signals and passes the signals to the coupling network 510. The coupling network 510 serves to separate the transmit signal going out to the antenna port from the receive signal coming in from the antenna port. The MUX 512 receives the signal and directs the signal to one of a plurality of outputs. For example, the MUX 512 may dynamically switch the input between the plurality of outputs based, at least in part, on the type of received signal. In some examples, example, the MUX 512 may switch the input to the transmission antenna 110 based, at least in part, on the received signal being compatible with a first type of RFID tag. In some examples, the MUX 512 may pass the signal to the converter 108 based, at least in part, on the signal being compatible with RFID tags that are foreign to the reader 106. For example, the MUX 512 may pass signals having a specified frequency to the converter 108. In the receive path, the MUX 512 receives signals from the antenna 110 and/or the converter 512. For example, the antenna 110 may receive signals from a first type of tag, and the converter 108 may receive signals from a second type of tag that communicates using a different frequency. The MUX 512 passes the received signal to the coupling network 510. The coupling network 510 serves to separate the transmit signal going out to the antenna port from the receive signal coming in from the antenna port. The LNA 514 amplifiers the received signal and passes the amplified signal to the mixer 504b. The mixer 504b demodulates the received signal by mixing the signal with the signal generated by the oscillator 504b and passes the baseband signal to the modem 502 for digital signal processing.

In some implementations, the converter 108 includes a microwave synthesizer 516, mixers 518a and 518b, microwave bandpass filter 520a and 520b, PA 522, coupling network 524, MUX 526, and LNA 528. In the transmit path, the reader 106 passes signals to the mixer 518a, and the microwave synthesizer 516 passes a microwave signal to the mixer 518a. The mixer 518a modulates the UHF signal using the microwave signal to generate transmission signals for a second type of RFID tag. The bandpass filter 520a substantially blocks frequencies outside a specified range of frequencies and pass the remaining frequencies to the PA 522. The PA 522 amplifies the modulated signals and passes the signals to the coupling network 524. The coupling network 524 serves to separate the transmit signal going out to the antenna port from the receive signal coming in from the antenna port. The MUX 526 receives the signal and directs the signal to one of a plurality of outputs. For example, the MUX 526 may dynamically switch the input between different antennas. In some examples, example, the MUX 526 may switch the input to the transmission antenna 112 based, at least in part, on an attribute of the transmission signal. In the receive path, the MUX 526 receives signals from an antenna. For example, the antenna 112 may receive signals from a second type of tag. The MUX 526 passes the received signal to the coupling network 524. The coupling network 524 serves to separate the transmit signal going out to the antenna port from the receive signal coming in from the antenna port. The LNA 528 amplifiers the received signal and passes the amplified signal to the filter 520b. The bandpass filter 520 passes a portion of the signal in a specified frequency range to the mixer 518b. The mixer 518b demodulates the received signal by mixing the signal with the signal generated by the oscillator 516 and passes the UHF signal to the reader 106. In some implementations, the separate receive and transmit lines between the RFID reader 106 and the transceiver 108 can be combined through a circulator such that a single line is connected to the reader 106. In some implementations, the system 500 may include a control line 530 between the reader 106 and the converter 108. In these instances, the reader 106 may dynamically modify the synthesizer 516 to update the communication frequency of the converter 108. For example, the 5.9 GHz may be updated to change frequencies using the control line 530.

A number of embodiments of the invention have been described. Nevertheless, it will be understood that various modifications may be made without departing from the spirit and scope of the invention. Accordingly, other embodiments are within the scope of the following claims.

What is claimed is:

1. A method, comprising:
receiving a request from a Radio Frequency Identification Device (RFID) reader configured to communicate with a first type of RFID tag;
automatically converting, independent of digital signal processing, the received request to a request compatible with a second type of RFID tag different from the first type of RFID tag; and
transmitting the converted request to an RFID tag of the second type of RFID tag.

2. The method of claim 1, wherein automatically converting, independent of digital signal processing, the received request comprises automatically converting the receive request from a first frequency to a second frequency independent of digital signal processing.

3. The method of claim 2, wherein the first frequency comprises 915 MegaHertz (MHz) signals.

4. The method of claim 1, wherein the second frequency 5.9 GigaHertz (GHz) signals.

5. The method of claim 1, wherein automatically converting the receive request from a first frequency to a second frequency comprises:
demodulating the received request from a first frequency to a baseband signal; and
directly modulating, independent of digital signal processing, the baseband signal to a second frequency to generate the converted request.

6. The method of claim 1, wherein automatically converting, independent of digital signal processing, the received request comprises automatically converting the receive request from a first RFID protocol to a second RFID protocol independent of digital signal processing.

7. The method of claim 1, wherein the first RFID protocol comprises Electronic Product Code (EPC) GEN 2.

8. The method of claim 6, wherein the second RFID protocol comprises Dedicated Short-Range Communications (DSRC).

9. The method of claim 1, wherein a passive transceiver receives the request and transmits the converted request transparent to the RFID reader.

10. The method of claim 1, further comprising:
receiving a reply from the RFID tag compatible with the second RFID protocol;
converting the reply to a form compatible with the RFID reader; and
transmitting the converted reply to the RFID reader.

11. The method of claim 1, further comprising presenting a slave transceiver as an RFID reader of the first type.

12. The method of claim 1, further comprising:
receiving a request from the RFID reader to update a communication frequency of transmitted signals; and
automatically updating a modulation frequency in response to at least the request.

13. An RF converter, comprising:
a receiver configured to receive a request from a Radio Frequency Identification Device (RFID) reader configured to communicate with a first type of RFID tag;
a converting module configured to automatically convert, independent of digital signal processing, the received request to a request compatible with a second type of RFID tag different from the first type of RFID tag; and
a transmitter configured to transmit the converted request to an RFID tag of the second type of RFID tag.

14. The converter of claim 13, the converting module further configured to automatically convert the receive request from a first frequency to a second frequency independent of digital signal processing.

15. The converter of claim 14, wherein the first frequency comprises 915 MegaHertz (MHz) signals.

16. The converter of claim 13, wherein the second frequency 5.9 GigaHertz (GHz) signals.

17. The converter of claim 13, the converting module further configured to:
demodulate the received request from a first frequency to a baseband signal; and
directly modulate, independent of digital signal processing, the baseband signal to a second frequency to generate the converted request.

18. The converter of claim 13, the converting module further configured to automatically converting the receive request from a first RFID protocol to a second RFID protocol independent of digital signal processing.

19. The converter of claim 13, wherein the first RFID protocol comprises Electronic Product Code (EPC) GEN 2.

20. The converter of claim 18, wherein the second RFID protocol comprises Dedicated short-range communications (DSRC).

21. The converter of claim 13, wherein a passive transceiver receives the request and transmits the converted request transparent to the RFID reader.

22. The converter of claim 13, further comprising:
the receiver further configured to receive a reply from the RFID tag compatible with the second RFID protocol;
the converting module further configured to convert the reply to a form compatible with the RFID reader; and
transmitter further configured to transmit the converted reply to the RFID reader.

23. The converter of claim 13, wherein presenting a slave transceiver as an RFID reader of the first type.

24. The converter of claim 13, further comprising:
the receiver further configured to receive a request from the RFID reader to update a communication frequency of transmitted signals; and
the converting module further configured to automatically update a modulation frequency in response to at least the request.

25. A system, comprising:
a means for receiving a request from a Radio Frequency Identification Device (RFID) reader configured to communicate with a first type of RFID tag;
a means for automatically converting, independent of digital signal processing, the received request to a request compatible with a second type of RFID tag different from the first type of RFID tag; and
a means for transmitting the converted request to an RFID tag of the second type of RFID tag.
